(19) United States
(12) Patent Application Publication
(10) Pub. No.: US 2002/0084597 A1
(43) Pub. Date: Jul. 4, 2002

(54) Process for manufacturing a sealing strip and strip obtained by this process

(75) Inventor: Sebastien Roux, Montargis (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: HUTCHINSON

(21) Appl. No.: 10/008,909

(22) Filed: Dec. 6, 2001

(30) Foreign Application Priority Data
Dec. 13, 2000 (FR) 0016217

(51) Int. Cl. F16J 15/02

(52) U.S. Cl. 277/628

(57) ABSTRACT

The invention relates to a process for manufacturing a sealing strip, in particular a seal or window slot seal of a motor vehicle, characterized in that it consists:

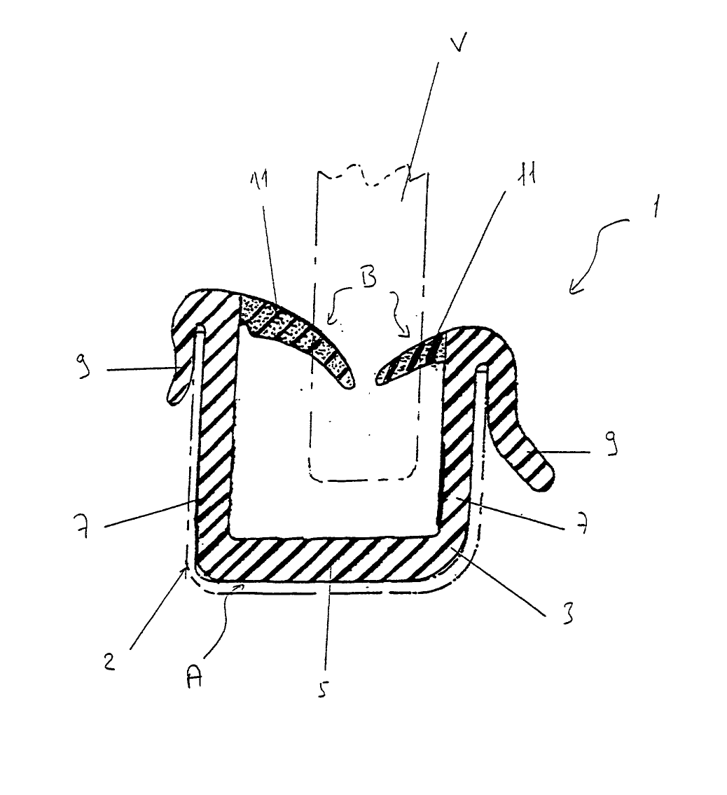

a) prior to the manufacture of the strip, in defining what are its dynamically functional portion (B) and its dynamically non-functional portion (A); and then

b) in manufacturing, by coextrusion, the said dynamically functional portion (B) and the said dynamically non-functional portion (A) from polymeric materials which differ from each other, the said constituent material of the dynamically non-functional portion (A) having a flexural modulus less than a value of the order of 100 MPa and being deformation-resistant up to a temperature of at least about 90° C.

The invention also relates to a sealing strip obtained by this manufacturing process.

The invention relates to a process for manufacturing a sealing strip, in particular a seal suitable for forming a window slideway or window slot seal, and to the strip obtained by this process.

In general and in many fields of industry, certain seals must be pliant in order to be able to match contours of shaped form. For this purpose, they are usually made of an elastomer (such as a natural rubber or an EPDM) or a thermoplastic elastomer (for example, PP/EPDM, SEBS, PVC/NBR or derivatives thereof), as described in particular in the French Patent published under the number 2 667 016.

The materials used hitherto in the manufacture of sealing strips nevertheless have the drawback of involving a high material cost. Furthermore, the use of elastomers means that the strip obtained must be vulcanized, which process involves a high production cost. However, the manufacture of competitively priced parts and products is an imperative for industrialists, this imperative being particularly acute in the motor vehicle industry.

It is therefore an object of the invention to provide a sealing strip whose manufacturing cost is less than that of currently existing strips, it being understood that the constituent material of the strip must be sufficiently pliant so as to be able to be shaped, in the case of a non-straight sealing strip.

The subject of the invention is therefore a process for manufacturing a sealing strip, in particular a seal suitable for forming a window slideway or window slot seal, this process being characterized in that it consists:

a) prior to the manufacture of the strip, in defining what are its dynamically functional portion and its dynamically non-functional portions; and then

b) in manufacturing, by coextrusion, the said dynamically functional portion and the said dynamically non-functional portion from polymeric materials which differ from each other, the said constituent material of the dynamically non-functional portion having a flexural modulus less than a value of the order of 100 MPa and being deformation-resistant up to a temperature of at least about 90° C.

Within the meaning of the present invention, the expression “dynamically functional portion” is understood to mean that portion of the strip which must in particular exhibit good elasticity, creep-resistance and compression-set properties. In the case of a strip being used as a seal, this portion corresponds especially to the sealing lips of the seal.

In contrast, the expression “dynamically non-functional portion” is understood to mean that portion of the strip which, apart from exhibiting pliancy allowing it to match the contours of the support to which it is fixed, need not exhibit a particular mechanical performance as regards especially elasticity, creep resistance and compression set.

In the process according to the invention, the dynamically non-functional portion may comprise, advantageously, one or more materials chosen from thermoplastics and thermoplastic elastomers.

The subject of the invention is also a sealing strip, characterized in that it comprises at least one dynamically functional portion, made from a first polymeric material, and at least one dynamically non-functional portion, which is made from a second polymeric material differing from the said first material, the said second material having a flexural modulus less than a value of the order of 100 MPa and being deformation-resistant up to a temperature of at least about 90° C., the said strip being obtained by the manufacturing process as defined above.

Such a strip may in particular consist of a window slideway or window slot seal, for example for a sliding window of a motor vehicle. However, it may of course be any type of strip that can be used, for example, in the building industry or in the motor vehicle industry and in particular for sealing applications, such as a door seal, boot seal, bonnet seal, windscreen seal, rear window seal, internal and/or external window slot seal, etc. It may also be a trim, that is to say a strip which is not intended to fulfil a sealing function.

The strip according to the invention has in particular the advantage of having a lower manufacturing cost than the strips known at the present time, because of the use, in that portion of the strip which is defined as being dynamically non-functional, of a material differing from that making up the dynamically functional portion, the said material being specifically selected for its low manufacturing cost and its low conversion cost, compared with those of the materials conventionally used for the manufacture of strips.

Further advantages, features and details of the invention will become apparent from the remainder of the description which follows, with reference to the appended drawing, given by way of example, which is a sectional view of a sealing strip in order to illustrate one way of implementing the process according to the invention.

The sealing strip 1 illustrated in the drawing is a section through a window slideway run which fixes to the upper and side portions of the frame 2 around the opening for a sliding window V of a motor vehicle, while a seal or window slot seal (not shown) fixes to the lower portion of the said frame.

In general, a seal forming a window slideway or a window slot seal comprises at least two portions, namely a first portion intended to provide a fixing function of the seal and a second portion intended to come into contact with the window V.

According to the example illustrated in the drawing, the seal 1 forming the window slideway comprises a fixing portion A consisting of a profiled body 3 having a straight or shaped cross section in the form of a U with a base 5 and two flanges 7. The body 3 is capable of fitting into a groove (not shown) formed in a rabbet of the frame 2 around the sliding-window opening. External retaining lips 9 are provided on the outer faces of the two flanges 7 in order to increase the pull-out strength of the body 3.

The seal 1 also comprises a sealing portion B consisting of two internal lips 11 which are located towards the upper ends of the two flanges 7, substantially facing each other and capable of coming into contact with the window V on each side of the latter.

According to the invention, the fixing portion A of the strip 1 is a dynamically non-functional portion, whereas its sealing portion B is a dynamically functional portion.

The body 3 of the strip 1 and the external retaining lips 9, which form the dynamically non-functional portion of the strip 1, are advantageously made of a material compatible, from a chemical standpoint, with that used to form the sealing lips 11. According to the invention, this material has a flexural modulus less than a value of the order of 100 MPa (measured according to the ISO 178 standard) and is deformation-resistant up to a temperature of at least about 90° C.

A suitable material for producing the dynamically non-functional portion of the strip may consist of an non-vulcanized polyolefin material and/or a thermoplastic elastomer.

As examples, the non-vulcanized polyolefin material that can be used to form the dynamically non-functional portion of the strip may be chosen from one or more of the following materials:

a polypropylene (PP) homopolymer containing at least one plasticizer;

a polypropylene copolymer, for example a polypropylene-polyethylene (PP/PE) copolymer;

a polyethylene (PE); and

a polypropylene/polyethylene blend.

In Any type of polyethylene may be used, for example an LDPE (low-density polyethylene), an HDPE (high-density polyethylene), or an LLDPE (linear low-density polyethylene).

As regards the thermoplastic elastomer that can be used, this may be chosen from one or more of the following materials:

a polypropylene/polyethylene/ethylene-propylene elastomer (PP/PE/EPR) copolymer;

a blend of a PP/PE copolymer and a thermoplastic elastomer;

a PP/PE/thermoplastic-elastomer copolymer; and

a Végaprène®.

As examples of materials that can be used, sold under the name Végaprène®, mention may be made of the materials described in the document WO 97/44390, which comprise at least one elastomer polymerized by a metallocene catalyst and a grafted polyolefin.

The expression “blend of a PP/PE copolymer and a thermoplastic elastomer” is understood to mean a physical blend of the said PP/PE copolymer with any thermoplastic elastomer chosen from all the thermoplastic elastomers known to those skilled in the art. Similarly the expression “a PP/PE/thermoplastic-elastomer copolymer” is understood to mean a copolymer comprising, within the same macromolecular chain, both PP/PE copolymer units and units of any thermoplastic elastomer chosen from all the thermoplastic elastomers known to those skilled in the art.

Among the thermoplastic elastomers mentioned above, a polypropylene/polyethylene/ethylene-propylene elastomer (PP/PE/EPR) copolymer is preferably used.

The internal sealing lips 11, which form the dynamically functional portion of the strip 1, are in fact intended to provide the sealing of the window of the motor vehicle and must possess, in particular, good elasticity, creep-resistance and compression-set properties. They may be made of any material known to those skilled in the art as having the above-mentioned properties and currently used in the manufacture of sealing lips. As examples, the sealing lips 11 may be made of a thermoplastic elastomer, of the PP/EPDM type or SEBS type.

The surfaces of the sealing lips 11 intended to come into contact with the window of the motor vehicle may be coated with a layer of crosslinked polyethylene (for example crosslinked using a silane) so as to allow the window to slide more easily between the said lips, as is described, in particular, in the document FR-A-2 730 783.

The strip shown in the drawing is advantageously manufactured by the process which consists:

a) prior to the manufacture of the strip, in defining what are its dynamically functional portion B and dynamically non-functional portion A; and then

b) in manufacturing, by coextrusion using a suitably shaped die, the said dynamically functional portion B and dynamically non-functional portion A from polymeric materials differing from each other, the said constituent material of the dynamically non-functional portion A having a flexural modulus less than a value of the order of 100 MPa and being deformation-resistant up to a temperature of at least about 90° C.

In step a) of the process described above, two dynamically functional portions and one dynamically non-functional portion are defined within the strip, these portions corresponding to the sealing lips 11 and to the body 3 with the retaining lips 9, respectively. The definition of these portions is done so as to demarcate them, one from another, in a manner compatible with manufacture by coextrusion.

In step b) of the process described above, the term “differing materials” is understood to mean materials whose chemical structures are not strictly the same, although these materials can belong to the same chemical polymer family. Such materials are like those described above.

Particularly advantageously, no vulcanization step is needed after the strip has been formed.

1. Process for manufacturing a sealing strip, in particular a seal suitable for forming a window slideway or window slot seal, characterized in that it consists:
a) prior to the manufacture of the strip, in defining what are its dynamically functional portion (B) and its dynamically non-functional portion (A); and then
b) in manufacturing, by coextrusion, the said dynamically functional portion (B) and the said dynamically non-functional portion from polymeric materials which differ from each other, the said constituent material of the dynamically non-functional portion (A) having flexural modulus less than a value of the order of 100 MPa and being deformation-resistant up to a temperature of at least about 90° C.

2. Process according to claim 1, characterized in that it consists in making the dynamically non-functional portion (A) from one or more materials chosen from thermoplastics and thermoplastic elastomers.

3. Process according to claim 2, characterized in that it consists in choosing a thermoplastic such as an non-vulcanized polyolefin material.

4. Process according to claim 3, characterized in that it consists in choosing a non-vulcanized polyolefin material from one or more of the following materials: a polypropylene (PP) homopolymer containing at least one plasticizer, a polypropylene copolymer, a polyethylene (PE) and a polypropylene/polyethylene blend.

5. Process according to claim 2, characterized in that it consists in choosing the said thermoplastic elastomer from one or more of the following materials:
a polypropylene/polyethylene/ethylene-propylene elastomer (PP/PE/EPR) copolymer, a blend of a PP/PE copolymer and a thermoplastic elastomer, a PP/PE/-thermoplastic-elastomer copolymer and a Végaprène®.

6. Sealing strip, characterized in that it comprises at least one dynamically functional portion (B), made from a first polymeric material, and at least one dynamically non-functional portion (A), which is made from a second polymeric material differing from the said first material, the said second material having a flexural modulus less than a value of the order of 100 MPa and being deformation-resistant up to a temperature of at least about 90° C., the said strip being obtained by the manufacturing process according to any one of the preceding claims.

7. Strip according to claim 6, characterized in that it is a slideway for a sliding-window opening of a motor vehicle.

8. Strip according to claim 6, characterized in that it is a window slot seal for a sliding-window opening of a motor vehicle.
